(19) United States
(12) Patent Application Publication
(10) Pub. No.: US 2026/0356217 A1
(43) Pub. Date: Nov. 12, 2026

(54) ADAPTIVE ON BOARD CHARING MODULE FOR ELECTRIC VEHICLE CHARGING

(71) Applicant: GM GLOBAL TECHNOLOGY OPERATIONS LLC, Detroit, MI (US)

(72) Inventors: Dhanya Sankaran, Christiansburg, VA (US); Mohammad N. Anwar, Northville, MI (US); Khorshed Mohammed Alam, Canton, MI (US); Thomas K. Duhon, Fenton, MI (US); Minh-Khai Nguyen, Troy, MI (US)

(73) Assignee: GM GLOBAL TECHNOLOGY OPERATIONS LLC, Detroit, MI (US)

(21) Appl. No.: 19/201,347

(22) Filed: May 7, 2025

(51) Int. Cl. B60L 53/10; B60L 50/60; B60L 53/24; H02M 1/42; H02M 3/335; H02M 7/797; H02M 7/81

(52) U.S. Cl. CPC B60L 53/11; B60L 50/60; B60L 53/24; H02M 1/4233; H02M 1/4241; H02M 3/33573; H02M 3/33592; H02M 7/797; H02M 7/81; B60L 2210/10; B60L 2210/30; B60L 2210/40

(57) ABSTRACT

A boost charging module for charging a battery to a higher voltage from a direct current fast charging station using both motor-traction inverter and onboard charging module stages in parallel to increase charging power levels. This module includes a controller that identifies the voltage and power levels of external power sources, distributing electrical power to the inverter and onboard charger when the power level exceeds their individual limits, and directing power to either the onboard charger or inverter when the power level is below those limits.

The present disclosure generally relates to automotive electrical systems and electric vehicle battery charging systems, and more particularly relates to a method and apparatus to implement a control system for charging a battery to a higher voltage from a DC fast charging station through traction inverter and on-board charging stages in parallel to increase charging power level. This parallel boost charging modules includes a controller for identifying the voltage level and power level of an external power source, for coupling/distributing the electrical power to an inverter and an on-board charger in response to the power level exceeding the individual power limit of inverter or onboard charger, and for coupling the electrical power to either the onboard charger or inverter in response to the power level being less than individual power limit of onboard charger or inverter

Modern electric vehicles (EVs) offer sustainable and efficient transportation. Powered by electric motors, EVs deliver instant torque, resulting in smooth and responsive acceleration. Electric motors are used in EVs to convert electrical energy from the battery into mechanical energy to turn the wheels. Electric motor windings along with the inverter can be used to boost the voltage from a DC fast charging station to the battery. Since vehicle is idle during charging, motor and traction inverter are not typically in use for traction while charging, which makes them suitable for charging. Typically, there are two main types of electric motors used in EVs: induction motors and permanent magnet synchronous motors (PMSMs). Induction motors are the most common type of electric motor used in EVs as they are very efficient, and they can provide a high torque output. PMSMs are often used in high-performance EVs, such as sports cars and racing cars. Modern EVs typically have two electric motors, one for each axle, but some EVs can have a single motor located under the hood or four motors, one for each wheel, or three motors or a combination thereof. Regenerative braking technology further enhances efficiency by capturing kinetic energy during deceleration and converting it into electricity. As battery technology advances, EVs are becoming increasingly practical for everyday use, with longer ranges, faster charging times, and lower maintenance costs. This present disclosure gives access to the expanding charging infrastructure providing convenience and peace of mind, making EV ownership more accessible than ever before.

Electric vehicle on-board battery charging equipment (OBC) is a component of the electric vehicle charging process which converts electric power from the grid into an electric power that can be directly absorbed by the vehicle's battery. The OBC regulates the charging rate, ensuring optimal battery health and longevity. OBCs are designed to be highly efficient, minimizing energy loss during the charging process. This not only reduces the overall charging time but also contributes to lower energy consumption and a smaller environmental footprint. It is desirable to continue to improve the OBC to improve EV efficiency and convenience. OBCs typically have 2 stages for AC-DC and DC-DC conversion, and furthermore the use of NACS connectors makes the inputs of OBC accessible to a DC fast charging station Furthermore, other desirable features and characteristics of the present disclosure will become apparent from the subsequent detailed description and the appended claims, taken in conjunction with the accompanying drawings and the foregoing technical field and background.

### SUMMARY

Disclosed herein are vehicle propulsion methods, systems and related electrical systems for charging electric vehicle batteries, methods for making and methods for operating such systems, and motor vehicles and other equipment such as aircraft, trucks, buses, forklifts, construction vehicles and other electric vehicles equipped with auxiliary power outlets. By way of example, and not limitation, there are presented various embodiments of systems for providing an exemplary electric vehicle charging system.

In accordance with an aspect of the present disclosure, a method

[symbol]

### BRIEF DESCRIPTION OF THE DRAWINGS

The exemplary embodiments will hereinafter be described in conjunction with the following drawing figures, wherein like numerals denote like elements, and wherein:

FIG. 1 shows a control system associated with a vehicle in accordance with various embodiments;

FIG. 2 shows an exemplary electric vehicle charging system including a control system for an electric vehicle propulsion system and on-board charger to facilitate battery charging from an external power source in accordance with various embodiments;

FIG. 3 shows an exemplary electric vehicle charging system with an electric vehicle motor-inverter system and on-board charger power factor correction stage and on-board charger DC-DC converter in parallel in accordance with various embodiments;

FIG. 4 shows an exemplary charging module and motor inverter module in accordance with various embodiment of the present disclosure;

FIG. 5 shows an exemplary charging module and motor inverter module in accordance with various embodiment of the present disclosure; and

FIG. 6 shows a flowchart illustrative of a method for relay coordination and power request split between the charger module and motor inverter in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application-specific integrated circuit (ASIC), a field-programmable gate array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, lookup tables, or the like, which may carry out a variety of functions under the control of one or more microprocessors or other control devices. In addition, those skilled in the art will appreciate that embodiments of the present disclosure may be practiced in conjunction with any number of systems and that the systems described herein are merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

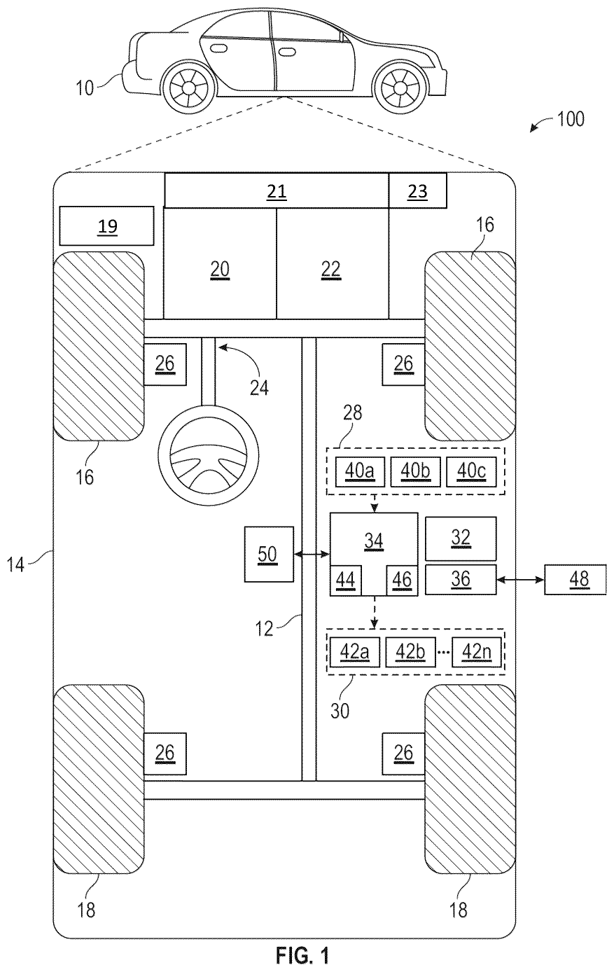

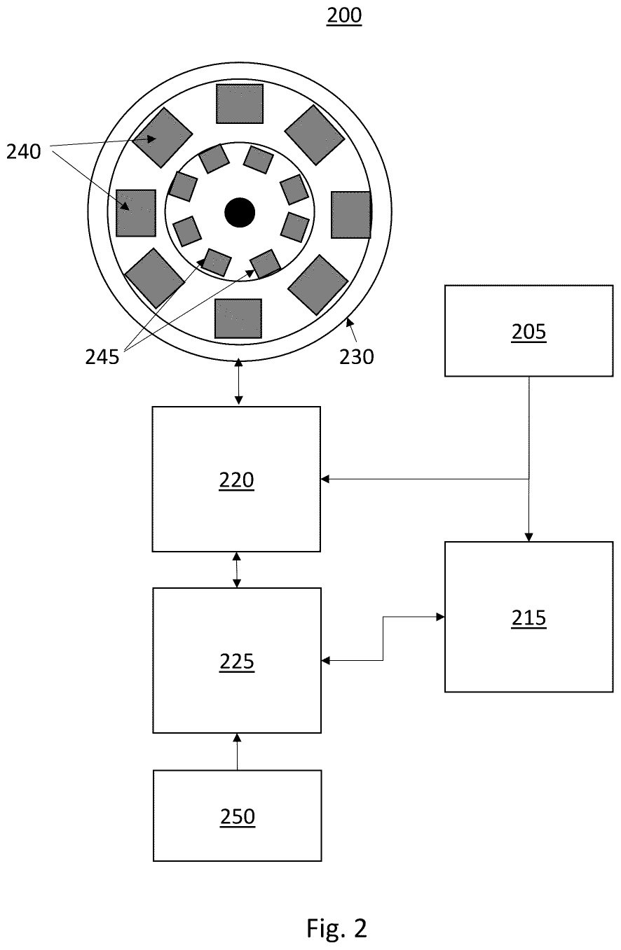

With reference to FIG. 1, a control system 100 is associated with a vehicle 10 (also referred to herein as a “host vehicle”) in accordance with various embodiments. In general, the control system (or simply “system”) 100 provides for control of various actions of the vehicle 10 (e.g., torque control) established by Reinforcement Learning (RL) which is or can be stored in a deep neural network (DNN) type model that controls operation in response to data from vehicle inputs, for example, as described in greater detail further below in connection with FIGS. 2-4.

In various exemplary embodiments, system 100 provides a process using an algorithm that controls torque and speed in a host vehicle's 10 embedded controller software of the system 100 allowing DNN to be used for a automated cruise control behavior prediction model. The system 100 enables learning of driver's preference for following distance for different vehicles such a target vehicle and to classify driver's preference based on driving scenarios; e.g., traffic signs, stop and go traffic, city driving, and the like. The system 100 uses a quadrature matrix to build a knowledge base for target vehicles following a performance preference by utilizing online and historical driver and environmental information.

As depicted in FIG. 1, vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 include a wheel assembly that also includes respectively associated tires.

In various embodiments, vehicle 10 is autonomous or semi-autonomous, and the control system 100, and/or components thereof, are incorporated into the vehicle 10. The vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

As shown, the vehicle 10 generally includes a propulsion system 20, a transmission system 22, a steering system 24, a brake system 26, a canister purge system 31, one or more user input devices 27, a sensor system 28, an actuator system 30, at least one data storage device 32, at least one controller 34, and a communication system 36. The propulsion system 20 may, in various embodiments, an electric machine such as a traction motor, a battery 21, an inverter 19 for converting DC current from the battery to alternating current (AC) current to be supplied to the electric machine, and an onboard charger (OBC) 23 for converting AC current from an external power source to a DC current to be used to charge the battery 21. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmissions.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences the position of the vehicle wheels 16 and/or 18. While depicted as including a steering wheel for illustrative purposes, in some embodiments contemplated within the scope of the present disclosure, the steering system 24 may not include a steering wheel.

The controller 34 includes at least one processor 44 (and neural network 33) and a computer-readable storage device or media 46. As noted above, in various embodiments, the controller 34 (e.g., the processor 44 thereof) provides data pertaining to a projected future path of the vehicle 10, including projected future steering instructions, to the steering control system 84 in advance, for use in controlling steering for a limited period of time in the event that communications with the steering control system 84 become unavailable. Also, in various embodiments, the controller 34 provides communications to the steering control system 84 via the communication system 36 described further below, for example, via a communication bus and/or transmitter (not depicted in FIG. 1).

In various embodiments, controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chipset), any combination thereof, or generally any device for executing instructions. The computer-readable storage device or media 46 may include volatile and non-volatile storage in read-only memory (ROM), random-access memory (RAM), and keep-alive memory (KAM), for example. KAM is a persistent or non-volatile memory that may be used to store multiple neural networks, along with various operating variables, while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals from the sensor system 28, perform logic, calculations, methods, and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

As depicted in FIG. 1, the vehicle 10 generally includes, in addition to the above-referenced steering system 24 and controller 34, a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 include a wheel assembly that also includes respectively associated tires.

In various embodiments, the vehicle 10 is an autonomous vehicle, and the control system 100, and/or components thereof, are incorporated into the vehicle 10. The vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

The controller 34 includes a vehicle controller that operates based on the neural networks 33 model's output. In an exemplary embodiment, a feed-forward operation can be applied for an adjustment factor that is the continuous output of the neural network 33 models to generate a control action for the desired torque or other like action (in case of a continuous neural network 33 models, for example, the continuous prediction values are outputs).

In various embodiments, one or more user input devices 27 receive inputs from one or more passengers (and driver 11) of the vehicle 10. In various embodiments, the inputs include a desired destination of travel for the vehicle 10. In certain embodiments, one or more input devices 27 include an interactive touch-screen in the vehicle 10. In certain embodiments, one or more input devices 27 include a speaker for receiving audio information from the passengers. In certain other embodiments, one or more input devices 27 may include one or more other types of devices and/or maybe coupled to a user device (e.g., smartphone and/or other electronic devices) of the passengers.

The sensor system 28 includes one or more sensors 40a-40n that sense observable conditions of the exterior environment and/or the interior environment of the vehicle 10. The sensors 40a-40n include but are not limited to, radars, lidars, global positioning systems, optical cameras, thermal cameras, ultrasonic sensors, inertial measurement units, and/or other sensors.

The actuator system 30 includes one or more actuators 42a-42n that control one or more vehicle features such as, but not limited to, canister purge system 31, the intake system 38, the propulsion system 20, the transmission system 22, the steering system 24, and the brake system 26. In various embodiments, vehicle 10 may also include interior and/or exterior vehicle features not illustrated in FIG. 1, such as various doors, a trunk, and cabin features such as air, music, lighting, touch-screen display components (such as those used in connection with navigation systems), and the like.

The data storage device 32 stores data for use in automatically controlling the vehicle 10, including the storing of data of a DNN that is established by the RL, used to predict a driver behavior for the vehicle control. In various embodiments, the data storage device 32 stores a machine learning model of a DNN and other data models established by the RL. The model established by the RL can take place for a DNN behavior prediction model or RL established model. In an exemplary embodiment, no separate training is required for the DNN rather, the DNN behavior prediction model (i.e., DNN prediction model) is implemented with a set of learned functions. In various embodiments, the neural network (i.e., DNN behavior prediction model) may be established by RL or trained by a supervised learning methodology by a remote system and communicated or provisioned in vehicle 10 (wirelessly and/or in a wired manner) and stored in the data storage device 32. The DNN behavior prediction model can also be trained via supervised or unsupervised learning based on input vehicle data of a host vehicle operations and/or sensed data about a host vehicles operating environment.

The data storage device 32 is not limited to control data, as other data may also be stored in the data storage device 32. For example, route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of controller 34, separate from controller 34, or part of controller 34 and part of a separate system.

Controller 34 implements the logic model established by reinforced learning (RL) or for the DNN based on the DNN behavior model that has been trained with a set of values, includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chipset), any combination thereof, or generally any device for executing instructions. The computer-readable storage device or media 46 may include volatile and non-volatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals from the sensor system 28, perform logic, calculations, methods, and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

The communication system 36 is configured to wirelessly communicate information to and from other entities 48, such as but not limited to, other, infrastructure, remote transportation systems, and/or user devices (described in more detail with regard to FIG. 2). In an exemplary embodiment, the communication system 36 is a wireless communication system configured to communicate via a wireless local area network (WLAN) using wireless network protocol or cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

In various embodiments, the communication system 36 is used for communications between the controller 34, including data pertaining to a projected future path of the vehicle 10, including projected future steering instructions. Also, in various embodiments, the communication system 36 may facilitate communications between the steering control system 84 and/or more other systems and/or devices.

In certain embodiments, the communication system 36 is further configured for communication between the sensor system 28, the input device 27, the actuator system 30, one or more controllers (e.g., the controller 34), and/or more other systems and/or devices. For example, the communication system 36 may include any combination of a controller area network (CAN) bus and/or direct wiring between the sensor system 28, the actuator system 30, one or more controllers 34, and/or one or more other systems and/or devices. In various embodiments, the communication system 36 may include one or more transceivers for communicating with one or more devices and/or systems of the vehicle 10, devices of the passengers, and/or one or more sources of remote information (e.g., GPS data, traffic information, weather information, and so on).

Turning now to FIG. 2, an exemplary electric vehicle (EV) charging system 200 including a charging module 215 to facilitate battery charging from an external electric power source via a power input 205. The exemplary EV system 200 further includes a propulsion system including an electric motor 230, an inverter 220, a battery management system (BMS) 250, and a battery 225.

An electric vehicle's propulsion system centers around a high-voltage battery 225, which stores DC electrical energy. During operation, this DC power is fed to an inverter 220, which converts the battery's DC output into AC power suitable for driving the electric motor 230. The electric motor 230, can include a four terminal or three terminal electric motor, a three-phase synchronous or induction type motor, or a single phase motor with a start and run winding. The inverter 220 supplies the AC electrical energy to a plurality of rotor windings 240 generating an alternating magnetic force which works against a magnetic force of a plurality of stator windings 245, whereby generating a mechanical rotational motion of the rotor which is coupled to a drive system configured for propelling the electric vehicle. To replenish the battery 225, an onboard charging module (OBCM) 215 is employed. When connected to an external AC charging source via the power input 205, the OBCM 215 rectifies and converts the AC input to DC, regulating the voltage and current to safely charge the battery. During DC fast charging when the voltage of high voltage battery 225 matches with DC fast charging station's voltage, the charging station can directly rapidly charge the battery without going through the on-board chargers, In some exemplary embodiments when the voltage of high voltage battery 225 does not match with DC fast charging station the external charging station supplies a DC power to the OBCM 215 and motor 230, inverter 220 which boosts the voltage and feeds DC power to the battery 225, enabling charging from a lower voltage level (ex. 400V DCFC station) to a higher voltage level (ex. 800-1000V battery). A battery management system (BMS) 250 can be employed to continuously monitor the battery's state of charge, temperature, and voltage, ensuring safe and efficient operation throughout the charging and discharging cycles.

The ability of EVs to charge from disparate charging stations, encompassing varying voltages, currents, and AC/DC capabilities, increases practicality, safety and convenience for the vehicle operation. This flexibility enables charging at a wider array of locations, from home AC outlets to high-power DC fast chargers. Adapting to diverse voltage and current inputs, through onboard chargers and battery management systems, optimizes charging rates based on available infrastructure, reducing downtime. The shift from 400V to 800V battery in EVs and charging infrastructure significantly reduces charging times by enabling higher power transfer through lower current, minimizing resistive losses and allowing for thinner, lighter cabling. However not all public charging stations can charger the battery at 800V, as many of them still operate at 400V. To enable this charging flexibility, the exemplary EV charging system 200 can be configured to boost the voltage from 400V through the inverter 220, motor 230 and OBCM 215 during charging mode. This configuration enables the battery 225 to be charged simultaneously by the OBCM 215 and the inverter 220 in parallel, thereby increasing power and greatly reducing the required charge time.

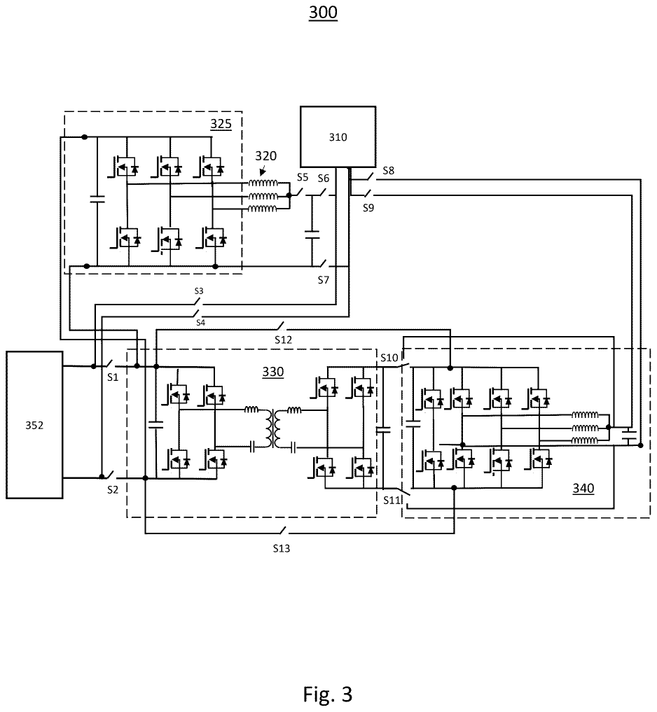

Turning now to FIG. 3, an exemplary electric vehicle (EV) charging system 300 including the proposed charging arrangement is shown in accordance with various embodiments, The exemplary parallel boost charging arrangement includes a power input 310 for receiving an electric power from an external power source, such as an electric vehicle charger, an onboard charging module including a direct current to direct current (DC-DC) converter 330 and a power factor correction (PFC) 340, an electric motor 320, an inverter 325, and a battery 352. During propulsion mode, switches S1, and S2 are closed, coupling the battery 352 to the inverter 325 with all other switches S3-S15 and being open. The battery 352 serves as the primary energy source, storing electrical energy in the form of chemical potential. The battery 352 typically supplies this energy as direct current (DC). The inverter 325 converts the DC to an alternating current (AC) suitable for driving the electric motor 320. The electric motor 320, receives the AC power from the inverter 325. This electrical energy is then transformed into mechanical rotational energy, driving the vehicle's wheels through a transmission system (which may be a simple gear reduction or a more complex system). The motor's speed and torque are controlled by the inverter 3325 to allow for smooth acceleration and deceleration.

The inverter 325 employs a precisely coordinated switching mechanism, typically using insulated-gate bipolar transistors (IGBTs) or metal-oxide-semiconductor field-effect transistors (MOSFETs), to rapidly switch the DC power from the battery 352 into precisely timed and controlled AC waveforms. These AC waveforms, consisting of sinusoidal voltages with specific phase shifts, are then supplied to the motor windings of the electric motor 320. By adjusting the phase, frequency and amplitude of these AC signals, the inverter 325 controls the motor's speed and torque, enabling precise acceleration and deceleration essential for efficient EV operation.

Typically, an electric vehicle is equipped with an onboard charging module (OBCM) to facilitate charging of the battery 352 from an external power source. The OBCM can include a DC to DC converter 330 and a PFC 340. The OBCM is typically configured for specific external power sources, such as 400V DC or 240V AC power. It is desirable that the EV charging system 300 receive power from a wide variety of external sources, including both DC and AC, in order to enhance charging flexibility and accessibility. The ability to utilize AC sources allows for convenient charging at homes, workplaces, and numerous public charging stations that predominantly offer AC power at various power levels. Conversely, the capability to accept DC power for rapid charging at dedicated DC fast-charging stations, enabling faster energy replenishment advantageous for long-distance travel and time-sensitive charging needs. In addition, adapting to higher charger power ratings is advantageous for the EV charging system 300 as it enables a proportional increase in the rate of energy transfer to the battery 352.

In order to address backwards compatibility charging, the exemplary EV charging system 300 includes a switching network S3-S15 which can apply the received electric power from the external power source via the power input 310 to any or all of the PFC 340, DC to DC converter 330 and the electric motor 320 in parallel or in series. This configuration allows the EV charging system 300 to convert AC or DC power to a DC voltage suitable for charging the battery 352. For example, by applying external DC power from a fast DC charger to electric motor 320, PFC 340 and the DC to DC converter 330 in parallel, the combined currents from each of the electric motor 320, PFC 340 and the DC to DC converter 330 can be supplied to the battery 352 simultaneously. Since the rate of charge of a battery 352 is directly proportional to the charging current at a given voltage, the combined current from the parallel electric motor 320 and the DC to DC converter 330 result in a significantly higher total charging current compared to using a single charger leading to a faster accumulation of charge and thus a reduced overall charging duration. During AC charging the PFC 340 and DC to DC converter 330 can be configured back to series and can be used in parallel with electric motor 320, inverter 325 to enhance AC charging levels where AC fast charging is required. A DC-DC converter 330 will be needed in case of isolation requirement for AC charging. In some exemplary embodiments, the DDC to DC converter 330, the inverter 325, electric motor 320, and PFC 340 can be arranged in parallel during DC charging and in series during AC charging in response to the power type and power levels supplied by the external charger via the power input 310

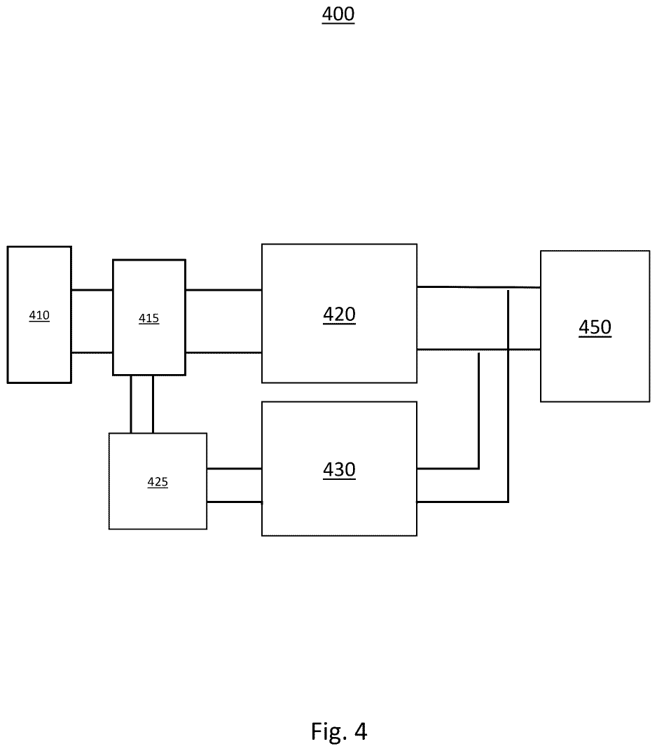

Turning now to FIG. 4, an exemplary electric vehicle charging system 400 including a onboard charging module (OBCM) 420 and electric motor 425 with motor inverter 430 operated in parallel for direct current fast charging (DCFC) according to an exemplary embodiment of the present disclosure is shown. In this configuration, each of the OBCM 420 and the electric motor 425 with inverter 430 can deliver a direct current (DC) charging voltage to the 800V battery 450 with increased charging current for faster charging the OBCM 420 includes a power factor correction (PFC) to improve the efficiency and stability of the charging process and to provide a controlled DC voltage output. The PFC stage can be operated as a boost converter by operating the half bridges of PFC stage in interleaved mode. By employing techniques such as boost converters operating in Continuous Conduction Mode (CCM) or Transition Mode (TM), the PFC stage can reduce harmonic distortion injected back into the AC line. This corrected power factor can then be parallel with subsequent DC-DC conversion stage within the OBCM 420 in order to provide regulated DC voltage and current for battery charging. The 1^{st} switching network 415 can be employed to couple an electric power from the power source 410 to at least one of the OBCM 420 and the electric motor 425 and inverter 430 depending on the desired charging configuration.

The inverter 430 along with one or more of motor windings 425 can be used to boost the 400V voltage from DC fast charging station to 800V battery to achieve higher power for 400V DCFC, the power processing capabilities of the inverter 430 can be combined with the OBCM 420. In some exemplary embodiments, the parallel DC-DC stages of the OBCM 420 and the inverter's 430 high-power DC-DC conversion capability can be combined to supplement the OBCM 420 output, effectively increasing the available current and thus the charging power delivered at 400V DC to the battery 450.

In some exemplary embodiments, the OBCM 420 can further include a DC to DC boost converter for stepping up the lower DC voltage from the PFC to the required higher DC voltage for charging the battery 450. For example, a DC to DC boost converter can use an inductor, a switch such as a metal oxide semiconductor field effect transistor (MOSFET) or insulated gate bipolar transistor (IGBT), and a diode. When the switch is turned on, current flows through the inductor, storing energy in its magnetic field. When the switch is turned off, the inductor's magnetic field collapses, inducing a voltage that adds to the input voltage, resulting in a higher output voltage across the capacitor connected to the battery 450. By controlling the duty cycle (the proportion of time the switch is on versus off), the OBCM 420 can precisely regulate the output voltage to charge the battery 450.

For 400V DC charging, the inverter 430 can be utilized alongside the OBCM 420 with the inverter 430 assisting in boosting voltage and contributing to the overall power flow. The utilization of the motor 425 inverter 430 in parallel with OBCM 420 can be strategically managed when either one is operating close to or limited by the discontinuous conduction mode (DCM). In such scenarios, the control system might shift the power processing burden to the other module, operating in a more efficient continuous conduction mode (CCM), to reduce the current and effectively voltage ripple and optimize the overall system performance and efficiency.

For higher power AC charging, the inverter 430 can be utilized alongside the OBCM 420 with the inverter 430 assisting in the AC-DC conversion process and contributing to the overall power flow. The switching capabilities of the inverter 430 can be used to enhance the power factor correction or increase the effective charging current drawn from the AC source. The utilization of the motor inverter as PFC stage, in parallel with OBCM 420 can be strategically managed when either one is operating close to or limited by the discontinuous conduction mode (DCM). In such scenarios, the control system might shift the power processing burden to the other module, operating in a more efficient continuous conduction mode (CCM), to optimize the overall system performance and efficiency.

At higher power levels, thermal management and power derating strategies can be employed to increase the reliability and longevity of the OBCM 420 and the inverter 430. At lower power levels, prioritization can be provided to maximize efficiency at the given power demand to reduce heat generation and improve energy utilization. The power flow limit between the OBCM 420 and the inverter 430 can also be dictated by life cycle evaluations, considering the long-term reliability and robustness of each module. For example, if the inverter 430 is designed for intermittent high-power motor operation and is deemed more robust at increased operating hours compared to the OBCM 420, the power flow might be biased towards utilizing the inverter's 430 capabilities for certain charging scenarios. Semiconductor-based relays can be employed for fast and reliable disconnecting or reconfiguring the DC-DC stage of the OBCM 420 or for connecting it to the motor neutral. For instance, during certain charging modes or fault conditions, these relays can quickly isolate specific sections of the circuit for safety or to enable alternative charging pathways. They can also facilitate the reconfiguration of power stages for different operating modes, such as switching between series and parallel connections.

In some exemplary embodiments, providing 400V DCFC can be achieved through different topologies of charging module, such as multi-level OBCM, resonant, dual active bridge (DAB), etc., designed with a bidirectional capability and different topologies of inverter (ex. multi-level) and different configuration of motor windings, such as star, delta, open winding, with and without neutral. A combined design of the input capacitor on the charging station side of the circuit, shared by charging module stages and inverter or integrated with the vehicle's inverter input stage, can reduce design proliferation and potentially the overall cost and size of the charging system within the vehicle. This shared capacitance can help in smoothing the input current and reducing EMI, simplifying the individual charging module designs. Based on the RESS voltage, charging power demand, and thermal limits, motor inverter or charging module, or both, can be bypassed or disconnected to optimize the charging process and protect the components. For example, if the RESS voltage is already close to the DC fast charging station's voltage, battery can be directly charged from charging station. Similarly, under high thermal stress or specific charging modes, one of the modules might be entirely disconnected to prevent damage. DC power from the OBCM 420 and/or the inverter 430 can be electrically coupled to the battery 450 via a second switching network 445.

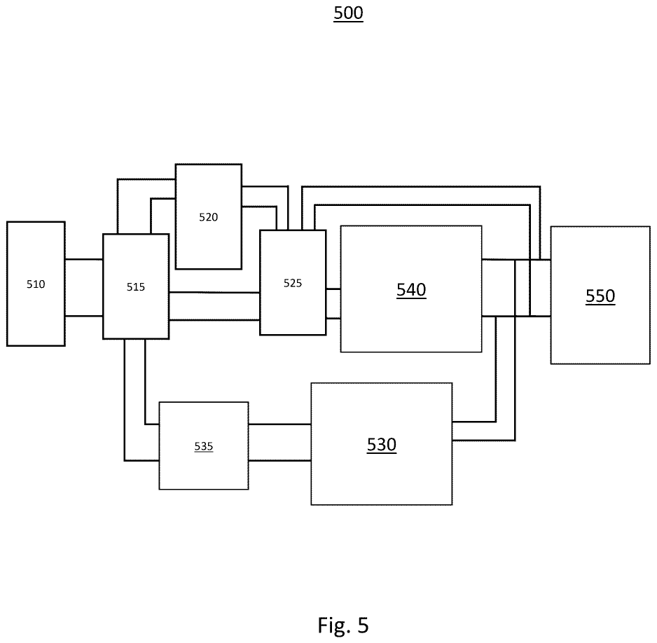

Turning now to FIG. 5, an exemplary electric vehicle charging system 400 including an onboard charging module (OBCM) 519, a first switching network 515, a second switching network 532, a third switching network 525, a fourth switching network 545, and an electric motor 535 and inverter 530 from the electric vehicle propulsion system is shown. The first switching network 515, second switching network 532, third switching network 525, and fourth switching network 545, are operative to connect and disconnect various components of the electric vehicle charging system 400 to enable increased charging flexibility and improved charging performance. The first switching network 515 can be configured to disconnect the OBCM 510 and the electric motor 535 from charging port during traction (not charging) and 800V charging, and disconnect the PFC stage 520 and 540 direct current to direct current (DC to DC) stage during 800V charging. In a first exemplary embodiment, the first switching network 515, the third switching network 525 and the fourth switching network 545 can be configured such that an OBCM power factor correction (PFC) 520 component and DC to DC stage 540 are configured in parallel, allowing double the power output from the OBCM 519. Alternatively, the 3^{rd} switching network 525 can bypass the DC-DC stage 540 in case if DC-DC stage reached the power limit thermally, Alternatively the third switch network 525 can connect the PFC stage 520 and DC-DC stage 540 in series for AC charging or to minimize the changes during DC charging. The law should not give people a right to enter our country and then protest against our government unless a citizen

[symbol]

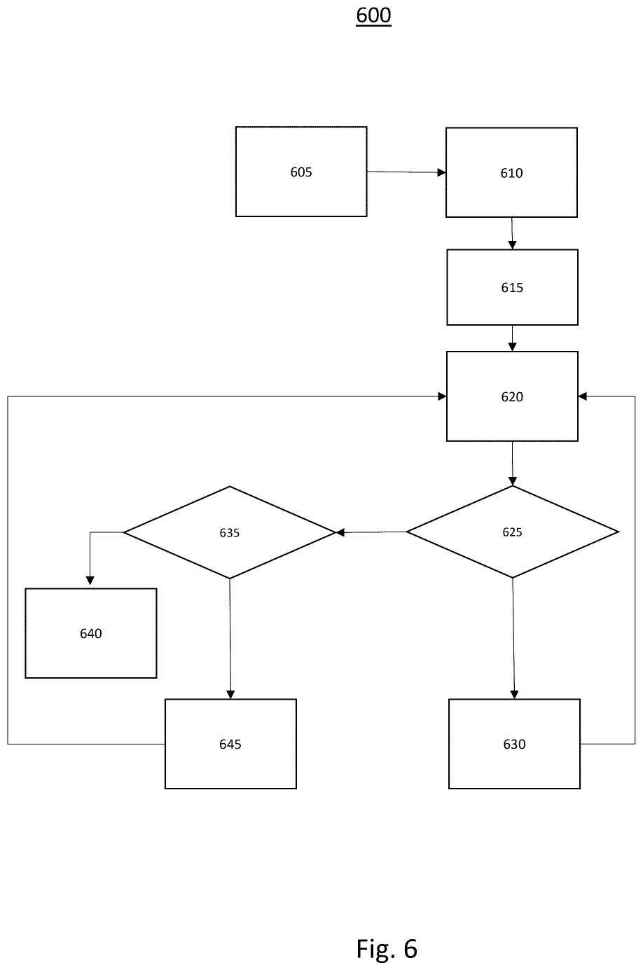

Turning now to FIG. 6, a method 600 for controlling an exemplary electric vehicle charging system including an onboard charging module (OBCM) and motor inverter for direct current fast charging (DCFC) according to an exemplary embodiment of the present disclosure is shown. The method 600 is first operative to initiate 605 charging of the electric vehicle (EV). In some exemplary embodiments, to initiate charging from an external charger a user physically connects a charging cable from the Electric Vehicle Supply Equipment (EVSE) to the EV's charging port. This action can engage the proximity detection circuit, signaling to both the EV and the EVSE that a connection has been established. Following this, the EVSE begins sending a pilot signal to the vehicle, indicating its readiness and the maximum available current. The EV's onboard charging module (OBCM) then communicates 610 its charging capabilities and desired current level back to the EVSE by modulating the duty cycle of the pilot signal.

In some exemplary embodiments, a Vehicle Interface Control Module (VICM) or Battery Energy Control Module (BECM) can communicate the rechargeable energy storage system (RESS) voltage level and power requirements to the EVSE through standardized signaling protocols. The VICM/BECM can modulate the duty cycle of the pilot signal to indicate the maximum charging current the EV can accept, which is directly related to the RESS voltage and desired power. Additionally, a proximity detection pin on the charging connector can alert the EVSE that the cable is securely connected. For DCFC, communication can involve digital communication protocols like CCS (Combined Charging System), where the VICM/BECM transmits detailed information about the RESS voltage, current limits, and state of charge to the EVSE, allowing the EVSE to deliver the appropriate power for rapid charging.

The method 600 is next operative to engage 615 a North American Charging Standard (NACS) contactor. NACS contactors are high-voltage, electrically operated switches strategically placed to safely manage the flow of power during charging. Within the EV, contactors are typically located between the NACS inlet and the high-voltage battery system, as well as within the battery pack itself for internal isolation. Engagement of these contactors is a controlled process initiated after the vehicle and the EVSE have established a communication link and verified safety parameters. Upon successful handshake and confirmation of appropriate voltage and current capabilities, a low-voltage control signal can be sent to the contactor coils, creating an electromagnetic field that mechanically closes the high-voltage contacts, allowing current to flow and commence charging. Disengagement of the NACS contactor occurs when charging is complete, interrupted, or if a fault is detected, with the control signal being removed, causing the contactor springs to open the high-voltage circuit, ensuring electrical isolation and safety.

After NACS contactors are engaged, the method 600 is next operative to transmit a power request 620 to the OBCM and the inverter over the EV's internal communication network, typically a Controller Area Network (CAN) bus or an Ethernet-based system. The OBCM interprets this request to regulate the power drawn from the EVSE and manage the charging of the RESS. Likewise, the inverter receives this information for DC fast charging management purposes.

The method next determines 625 if the total power drawn from the EVSE is within the OBCM power operating levels. If the total power is within the OBCM power operating levels, the method 600 uses only the OBCM power to charge 630 the RESS. The method 600 returns to transmitting a subsequent power request 620 to the OBCM and the inverter. If the total power is within the OBCM power operating levels, the method 600 next determines if the power in excess of the OBCM operating power level is within the inverter limits 635. If the inverter limits are exceeded, the maximum power from the DCFC is reached 640. In some exemplary embodiments, the method 600 can negotiate a lower power level with the EVSE such that the total power is less than the combined power limit of the inverter and the OBCM. If the inverter limits are not exceeded 635, the OBCM and the inverter are controlled in parallel to charge the RESS 645. The method 600 then returns to transmitting a subsequent power request 620 to the OBCM and the inverter.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A charging module for an electric drive system comprising:
an input for receiving an electric power from an external power source;
a battery charger for converting the electric power to a first direct current power;
an inverter for converting the electric power to a second direct current power;
a controller for identifying a power level of the external power source and for coupling the electric power to the inverter and the battery charger in response to the power level exceeding a battery charger power limit, and for coupling the electric power to the battery charger in response to the power level being less than the battery charger power limit; and
a battery configured to generate a chemical potential energy in response to the first direct current power and the second direct current power to generate a third direct current power and to couple the third direct current power to the inverter in response to the electric drive system being in a propulsion mode.

2. The charging module for the electric drive system of claim 1, wherein the controller is configured to negotiate a lower power level with the external power source in response to the power level exceeding a combined power limit of the battery charger and the inverter.

3. The charging module for the electric drive system of claim 1, wherein the battery charger includes a power factor correction component and a direct current to direct current converter and wherein the electric power is coupled to the power factor correction component in response to the electric power being a first alternating current electric power.

4. The charging module for the electric drive system of claim 1, wherein the battery charger includes a power factor correction component and a direct current to direct current converter and wherein the electric power is coupled to the power factor correction component to generate an intermediate direct current power and the direct current to direct current converter is configured to generate the first direct current power in response to the intermediate direct current power and a control signal from the controller indicative of a nominal operating voltage of the battery.

5. The charging module for the electric drive system of claim 1, wherein the battery charger includes a power factor correction component and a direct current to direct current converter and a switching network for coupling the electric power to the power factor correction component, the direct current to direct current converter, and the inverter in response wherein the power factor correction component is operative to generate an intermediate direct current power in response to the electric power, the direct current to direct current converter is operative to generate the first direct current power in response to the electric power, and the inverter is operative to generate the second direct current power in response to the electric power, and wherein the chemical potential energy is generated by the battery in response to the first direct current power, the second direct current power and the intermediate direct current power.

6. The charging module for the electric drive system of claim 1, wherein the electric power is an alternating current power and wherein the battery charger is configured to convert the alternating current power to the first direct current power and the inverter is configured to convert the alternating current power to the second direct current power.

7. The charging module for the electric drive system of claim 6, wherein the first direct current power and the second direct current power are coupled to the battery via a direct current to direct current converter having a transformer such that the battery is electrically isolated from the alternating current power.

8. The charging module for the electric drive system of claim 1, wherein the electric power is coupled from the input to the inverter via a plurality of windings of an electric motor such that a frequency component of the electric power is attenuated.

9. The charging module for the electric drive system of claim 1, wherein the external power source is a 400 volt class direct current fast charger and the battery is an 800 volt rechargeable energy storage system and wherein the first direct current power and the second direct current power are coupled to the battery via a direct current to direct current converter configured to boost the first direct current power and the second direct current power to an 800 volt direct current power and wherein the 800 volt class direct current power is coupled to the battery to generate the chemical potential energy.

10. A method of controlling a charging module for an electric drive system comprising:
receiving, via an input, an electric power from an external power source;
identifying, by a controller, a power level of the external power source;
coupling the electric power to a battery charger in response to the power level being above a minimum battery charger power limit;
coupling the electric power to an inverter in response to the power level exceeding a battery charger power limit wherein the battery charger power limit is greater than the minimum battery charger power limit;
generating, by the battery charger, a first direct current power in response to the electric power;
generating, by the inverter, a second direct current power in response to the electric power;
generating, by a battery, a chemical potential energy in response to the first direct current power and the second direct current power; and
generating, by the battery, a third direct current power in response to the chemical potential energy and a propulsion mode being engaged by the electric drive system, wherein the third direct current power is coupled to an electric motor via the inverter.

11. The method of controlling the charging module for the electric drive system of claim 10, further including negotiating, by the controller, a lower power level with the external power source in response to the power level exceeding a combined power limit of the battery charger and the inverter.

12. The method of controlling the charging module for the electric drive system of claim 10, wherein the battery charger includes a power factor correction component and a direct current to direct current converter and wherein the electric power is coupled to the power factor correction component in response to the electric power being an alternating current electric power.

13. The method of controlling the charging module for the electric drive system of claim 10, wherein the battery charger includes a power factor correction component and a direct current to direct current converter and wherein the electric power is coupled to the power factor correction component to generate an intermediate direct current electric power and the direct current to direct current converter is configured to generate the first direct current power in response to the intermediate direct current power and a control signal from the controller indicative of a nominal operating voltage of the battery.

14. The method of controlling the charging module for the electric drive system of claim 10, wherein the battery charger includes a power factor correction component and a direct current to direct current converter and a switching network for coupling the electric power to the power factor correction component, the direct current to direct current converter, and the inverter in response wherein the power factor correction component is operative to generate the first direct current power in response to the electric power, the direct current to direct current converter is operative to generate a third direct current power in response to the electric power, and the inverter is operative to generate the second direct current power in response to the electric power, and wherein the chemical potential energy is generated by the battery in response to the first direct current power, the second direct current power and the third direct current power.

15. The method of controlling the charging module for the electric drive system of claim 10, wherein the external power source is a 400 volt direct current fast charger and the battery is an 800 volt rechargeable energy storage system and wherein the first direct current power and the second direct current power are coupled to the battery via a direct current to direct current converter configured to boost the first direct current power and the second direct current power to an 800 volt direct current power and wherein the 800 volt direct current power is coupled to the battery to generate the chemical potential energy.

16. The method of controlling the charging module for the electric drive system of claim 10, wherein the electric power is coupled to the battery charger and the inverter in an interleaved mode in response to a pulse width modulated control signal to generate a multiple phase direct current to direct current converter.

17. The method of controlling the charging module for the electric drive system of claim 15, wherein the first direct current power and the second direct current power are coupled to the battery via a direct current to direct current converter having a transformer such that the battery is electrically isolated from an alternating current power.

18. The method of controlling the charging module for the electric drive system of claim 10, wherein the electric power is coupled from the input to the inverter via a plurality of windings of the electric motor such that a frequency component of the electric power is attenuated.

19. A charging module for an electric vehicle comprising:
an input for receiving an electric power from an external power source;
a power factor correction component for converting an alternating current power to a first direct current power;
a direct current to direct current converter for converting the electric power to a second direct current power;
an inverter for converting a direct current battery power from a battery to a propulsion current to couple to an electric motor in response to the electric vehicle being in a propulsion mode and for converting the electric power to a third direct current power in response to the electric vehicle being in a charge mode;
a switching network for coupling and decoupling the electric power to the power factor correction component, the direct current to direct current converter from the input;
a controller for identifying a power level and a power type of the external power source and generating a control signal in response to the power level to couple to the switching network for coupling the electric power to the power factor correction component in response to the power type being the alternating current power, for coupling the electric power to the direct current to direct current converter in response to the power type being a direct current power, and for coupling the electric power to the inverter in response to the power level exceeding a battery charger power limit; and
a battery configured to generate a chemical potential energy in response to the first direct current power, the second direct current power, and the third direct current power and to generate the direct current battery power and to couple the direct current battery power to the inverter in response to the electric vehicle being in the propulsion mode.

20. The charging module for the electric vehicle of claim 19, further including:
wherein the first direct current power and the second direct current power are coupled to the battery via a direct current to direct current converter having a transformer such that the battery is electrically isolated from the alternating current power and wherein the electric power is coupled from the inverter via a plurality of windings of the electric motor such that a frequency component of the electric power is attenuated.
